(19) United States
(12) Patent Application Publication
(10) Pub. No.: US 2022/0248634 A1
(43) Pub. Date: Aug. 11, 2022

(54) HAY BASKET APPARATUS

(71) Applicant: The Board of Regents for the Oklahoma Agricultural and Mechanical Colleges, Stillwater, OK (US)

(72) Inventors: DAVID LEON LALMAN, PAWNEE, OK (US); AMANDA LEIGH HOLDER, POINT LOOKOUT, MO (US)

(73) Assignee: The Board of Regents for the Oklahoma Agricultural and Mechanical Colleges, Stillwater, OK (US)

(21) Appl. No.: 17/668,953

(22) Filed: Feb. 10, 2022

Related U.S. Application Data
(60) Provisional application No. 63/147,792, filed on Feb. 10, 2021.

(51) Int. Cl. A01K 1/10

(52) U.S. Cl. CPC A01K 1/105

(57) ABSTRACT

One purpose of the an embodiment basket is to increase the capacity for long-stemmed hay in automated individual intake units. The inventive hay basket is a removable addition to an automated feeding system bunk that effectively triples the hay capacity as compared with the commercially available system alone. According to one embodiment, the hay basket includes a rotatable swing gate that can be used to control the amount of access an animal has to hay in the basket. Without the hay basket addition, accurate hay intake collection would not be possible on a useful number of animals. The inventive hay basket reduces waste and increases the carrying capacity of the dry lot pen.

### CROSS REFERENCE TO RELATED APPLICATIONS

This application claims the benefit of U.S. Provisional Patent Application Ser. No. 63/147,792 filed on Feb. 10, 2021, and incorporates said provisional application by reference into this document as if fully set out at this point.

### TECHNICAL FIELD

The instant invention relates generally to an apparatus for feeding cattle.

### BACKGROUND

Commercially available livestock feeding systems are well known and can automatically provide customized individual feeding of a herd of livestock that is housed in the same pen or pasture. This is done by affixing an RFID tag to each animal and then providing one animal at a time access to the feeding bin by creating gates or guides that are narrowed so that only one animal is able to reach the food in the bin. Each animal in the herd is fitted with a unique RFID or similar technology ear tag that allows it to be identified when its head is within the feeding bin. Then, the amount of food consumed may be readily determined by, for example, recording the starting and ending weight of the contents of the bin during a visit by each animal. Beyond the amount of food consumed by each animal, the number of visits and the amount of time each animal spends in the feeder is also recorded by the system. Of course, this approach may be generalized to multiple animals by providing additional bins, electronic sensors, and automated food delivery units.

Companies producing “individual animal feed intake measurement systems” may offer more than one size of feed bin to accommodate different size animals and different ration types. For example, regardless of feed bin size, each feeder can hold more mass (or pounds) of a dense grain-based ration compared to a bulky ration that contains a lot of roughage products, such as ground (processed) hay, silage, or cottonseed hulls. However, these feed intake systems cannot accommodate feeding of bulky, long-stem (unprocessed), baled hay and, other harvested forage including, by way of example only, and cut, dried, and baled grass forages, legume forages a combination of the two, etc. This is important because in the beef cattle industry, growing calves and finishing cattle may be fed these grain-based diets for brief periods of time. However, most beef cows spend their productive lives consuming unprocessed hay during fall and winter and standing (unprocessed) forage in pastures during spring and summer. As such, it should be noted that when “hay” is mentioned herein that term should be broadly construed to include any of the foregoing.

In some cases, the feeding bin may be surmounted by a storage bin that contains the material that is to be dispensed. Some varieties can hold up to 5,000 pounds of feed, e.g., a pelleted food supplement, which can be easily metered and dispensed. However, this sort of arrangement is generally not suitable for use with bulky feeds such as long-stemmed hay.

Thus, what is needed is an apparatus that overcomes the limitations of prior art and that can be used with bulky feeds such as long-stemmed hay.

Before proceeding to a description of the present invention, however, it should be noted and remembered that the description of the invention which follows, together with the accompanying drawings, should not be construed as limiting the invention to the examples (or embodiments) shown and described. This is so because those skilled in the art to which the invention pertains will be able to devise other forms of this invention within the ambit of the appended claims.

### SUMMARY OF THE INVENTION

According to one embodiment, one function of the inventive hay basket is to increase the capacity for long-stemmed hay in the automated individual intake units. One of the main obstacles encountered in research studies collecting hay intake data for beef cattle is the bulkiness of the feedstuff (hay), however, amendments made to the diet that help to decrease bulkiness (reducing particle size, adding moisture, etc.) also affect an animal's intake and do not provide an accurate representation of intake of an average animal in the field. The inventive hay basket is a removable addition to the automated feeding system bunk that effectively triples the hay capacity as compared with the commercially available system alone.

One important feature of some embodiments is that one wall of the inventive hay basket is rotatably mounted at its top and can be rotated to increase or decrease the volume of the hay basket. One function of this aspect is to cause the feed that is dropped into the instant device to slide downward toward the animal. This makes it possible for the animal to more easily reach the hay that is present inside and decreases the likelihood that the feed will be wasted.

The foregoing has outlined in broad terms some of the more important features of the invention disclosed herein so that the detailed description that follows may be more clearly understood, and so that the contribution of the instant inventors to the art may be better appreciated. The instant invention is not to be limited in its application to the details of the construction and to the arrangements of the components set forth in the following description or illustrated in the drawings. Rather, the invention is capable of other embodiments and of being practiced and carried out in various other ways not specifically enumerated herein. Finally, it should be understood that the phraseology and terminology employed herein are for the purpose of description and should not be regarded as limiting, unless the specification specifically so limits the invention.

### BRIEF DESCRIPTION OF THE DRAWINGS

These and further aspects of the invention are described in detail in the following examples and accompanying drawings.

FIG. 1 illustrates the general environment of the invention;

FIG. 2 shows a side view of an embodiment;

FIG. 3A and FIG. 3B illustrate how an animal might feed when hay is loaded into an embodiment;

FIG. 4 contains a closeup of a portion of a swing gate according to an embodiment; and

FIG. 5 contains a perspective view of an embodiment;

The invention will be described in connection with its preferred embodiments. However, to the extent that the following detailed description is specific to a particular embodiment or a particular use of the invention, this is intended to be illustrative only and is not construed as limiting the invention's scope. On the contrary, it is intended to cover all alternatives, modifications, and equivalents included within the invention's spirit and scope, as defined by the appended claims.

### DETAILED DESCRIPTION

While this invention is susceptible of embodiment in many different forms, there is shown in the drawings, and will be described hereinafter in detail, some specific embodiments of the instant invention. It should be understood, however, that the present disclosure is to be considered an exemplification of the principles of the invention and is not intended to limit the invention to the specific embodiments or algorithms so described.

One purpose of the inventive hay basket is to increase the capacity for long-stemmed hay in individual intake units and, especially, automated intake units. One of the main obstacles encountered in research studies that collect hay intake data for beef cattle is the bulkiness of the feedstuff (e.g., hay), however, changes made to the animals' diet that help to decrease bulkiness (e.g., reducing particle size, adding moisture, etc.) also affect an animal's feed intake which results in an inaccurate representation of the intake of an animal in the field.

The inventive hay basket in some embodiments can be configured to be a removable addition to and sit atop of an automated feeding system bunk of the sort manufactured by C-Lock™ called the SmartFeed™ system. Adding the inventive hay basket to that system effectively triples its hay capacity as compared with the commercially available system alone. Speaking generally, these sorts of feeding/monitoring systems may be powered by AC current or may be self-contained (e.g., the electronics may be solar powered) and are designed to measure the amount of food consumed from individual animals in a herd. Individuals in the herd may be identified via the use of an RFID tag (full or half duplex) affixed to the animal, typically on an ear. These systems typically contain an integrated or additional scale that continuously measures the weight of the bin contents (which may include the weight of the bin) over time. This information, when coupled with information from the RFID ear tag makes it possible to tabulate the amount of feed consumed by each animal. The information that is collected might be stored locally or communicated via either a wire or wirelessly to a remote data collection facility for analysis.

According to one embodiment, the inventive hay basket includes a rotatable swing gate as can be seen in throughout the figures that can be used to control the degree of access an animal has to hay that has been loaded into the instant apparatus without allowing the animal to stick its head completely into the feeder. Without the hay basket addition, an accurate measurement of hay intake collection may not be possible on a useful number of animals. The inventive hay basket reduces waste and increases the carrying capacity of the dry lot pen.

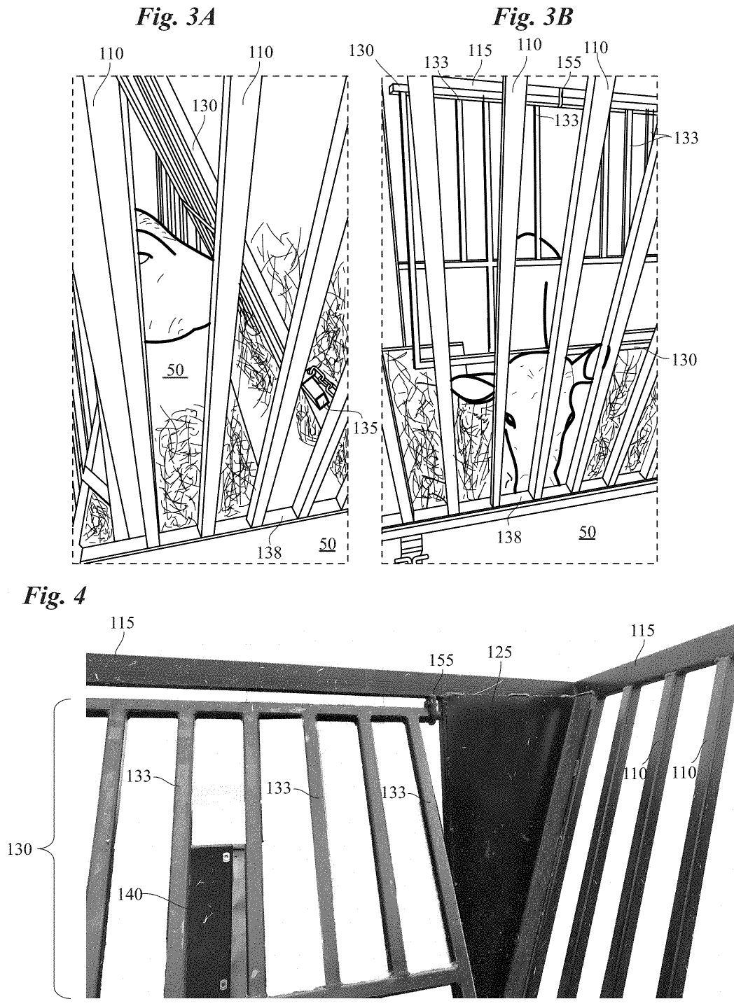

Turning first to FIGS. 1 and 3A/3B, these figures illustrate the general environment of the invention. As is generally indicated in FIG. 1, an embodiment of the instant hay basket 100 is designed to be used with an automated feeding system bunk 50 of the sort discussed previously. That being said, it should be clear that the instant device could readily be used with a wide variety of feed bunks, troughs, or bins whether automated or not. As is indicated in FIGS. 3A and 3B, the instant embodiment is designed to limit an animal's access to the feed contained therein while restricting the animal's ability to withdraw uneaten feed from the basket 100/bunk 50 combination where it could be dropped on the ground. Feed that is dropped outside the feed bunk 50 but not eaten can make quantitative measurements of each animal's feed consumption inaccurate and, as such, should be avoided to the extent possible.

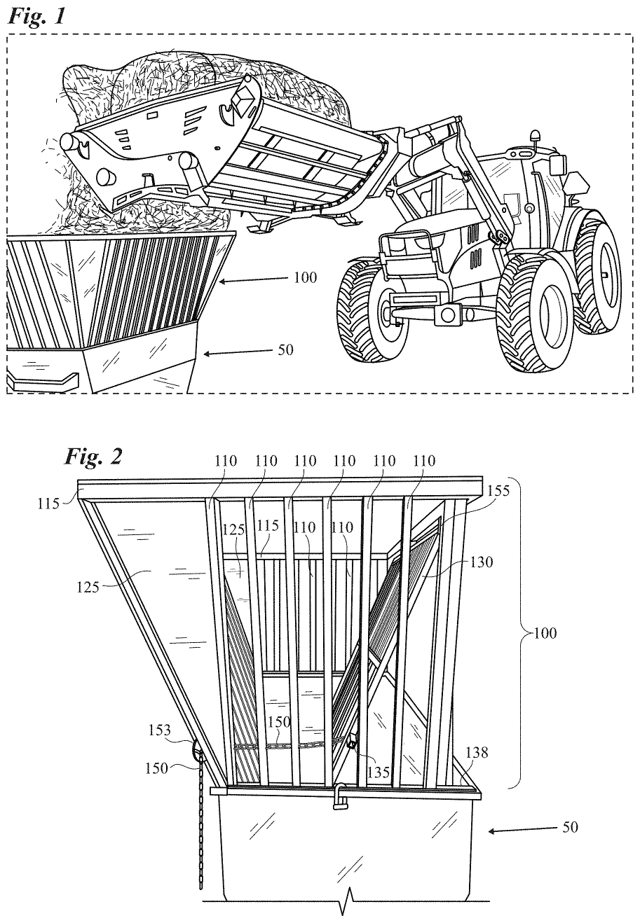

In one embodiment, the dimensions of the hay basket and recline angle of basket's side walls were designed to fit mostly commonly used round hay bales which are 48″ wide×60″ in diameter (e.g., FIG. 1, FIG. 2, and FIG. 5). However, small cubical hay bales or large cubical hay bales can also be easily loaded into an embodiment of the inventive basket. This inventive structure helps to minimize the amount of hay that is wasted during loading of hay into the basket 100. For example, embodiments of the inventive basket are made wider at the top to minimize the amount of hay wasted during loading (e.g., FIG. 1).

In the variation of FIG. 5, the basket 100 comprises a rectangular upper frame member 115 and a lower frame member 138 connected on three sides by a plurality of spaced apart structural struts, i.e., stationary frame members 110. Note that the dimensions of the upper and lower frame members might be different, e.g., it is preferable that the dimensions of the upper frame member 115 are larger than those of the lower frame member 138 for reasons discussed previously. In any case, the lower frame member 138 should have dimensions at least as large as those of the upper frame member 115, e.g., the perimeter of the upper frame member 115 should be greater than or equal to that of the lower frame member 115. As such, the term “commensurate with” will be used hereinafter to describe the size relationship between these two members, i.e., when it is said that the lower frame member 138 has dimensions “commensurate with” those of the upper frame member 115 that phrase should be interpreted to be that the upper frame member 115 has dimensions that are the same as those of the lower frame member 138 or larger.

Additionally, note that in this embodiment the lower frame member 138 is not a complete rectangle but is open on the side of the swing gate 130 discussed below. It certainly could have been a closed (complete) rectangle and the instant invention would operate similarly if it had been designed that way. As such, when the lower frame member 138 is referred to as being “rectangular” hereinafter, that term should be broadly construed to include instances where it comprises a closed rectangle, as well as the case illustrated in FIG. 5 where it has an open side that, if closed, would complete the rectangle.

The fourth side of the basket 100 comprises a swing gate 130. The feeding access gate or swing gate 130 comprises a rectangular frame that includes a plurality of spaced apart struts 133 that connect its top and bottom and provide an open grid through which feed in the basket 100 may be accessed by an animal. The upper frame member 115 supports the swing gate 130 by way of a plurality of hinges 155 that are affixed to the top of the swing gate 130. The hinges 155 might be bushings, bearings, or some other mechanism. This arrangement allows the swing gate's 130 angle with respect to the vertical to be adjusted. As can be seen, the swing gate 130 is rotatable to increase and decrease the volume of the interior of the inventive hay basket 100.

Preferably, the swing gate 130 will be configured to be fixed in place after it has been rotated to a desired angle. In some cases, a chain 150 and latch 153 combination (FIG. 2) that are situated on each end of the swing gate 130 might be used to secure it (FIG. 2). Only one such chain/latch combination is illustrated in FIG. 2 but, preferably, the swing gate 130 would have an additional chain/latch combination on its other end. In some embodiments as an alternative the swing gate 130 might be removably attached (e.g., using a chain, rope, clamp, etc.) to a stationary frame member 110 to hold it in place after it has been rotated to a desired orientation. Either approach allows the swing gate 130 to be adjusted to a wide range of reclines/angles so as to minimize hay waste when the cow is feeding from the basket. In some cases a protuberance or peg 135 might act as a stop to limit the ability of the swing gate 130 to rotate outward beyond the extent of the lower frame member 138 (FIGS. 2 and 5).

The inventive hay basket's swing gate 130 is designed to help minimize the amount of hay that might be wasted when the cow is feeding from the hay basket 100. For example, by rotating the swing gate 130 around its pivot point at its top the space available to the animal to access the feed for feed within can be increased or decreased.

Turning next to FIG. 2, this figure illustrates in greater detail some aspects of an embodiment. As can be seen, the instant invention 100 is designed to be used in conjunction with and sit atop a feed bin 50 of some sort. The stationary frame members 110 might be square steel tubes or some other suitable material. The upper periphery 115 of the instant embodiment 100 (FIGS. 2 and 5) provides a generally rectangular top although other configurations are certainly possible. In some embodiments, side panels 125 at the corners of the basket 100 might be provided in to reduce the amount of feed that would normally be lost on the sides of the basket 100. In the current embodiment the side panels 125 are roughly triangular in shape and are larger at the top than at the bottom. Obviously, the shape and placement of the side panels 125 is something that can be varied according to need and those of ordinary skill in the art will readily be able to determine the parameters that are most useful in a particular situation.

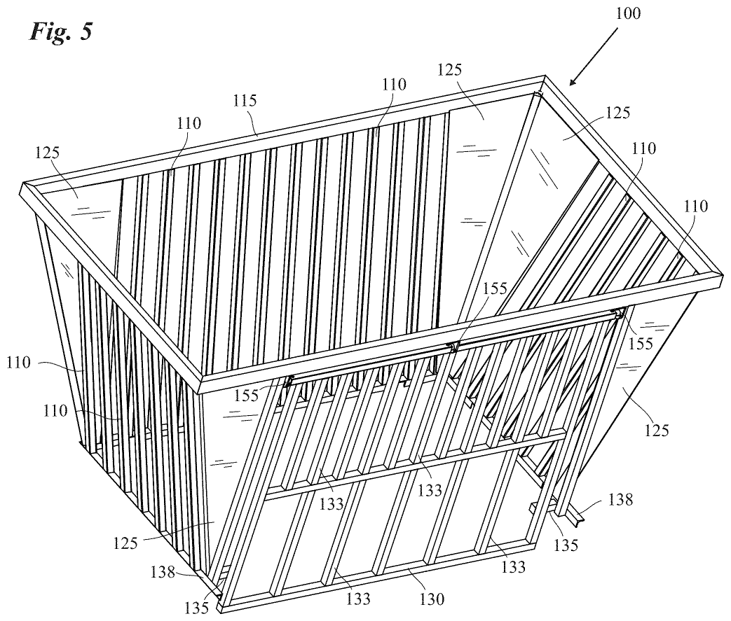

FIG. 4 contains a more detailed illustration of how the swing gate 130 might be rotatably mounted on the upper frame member 115 using hinges 155. This embodiment also includes an RFID sensor 140 which can be used to identify each cow that takes hay from the inventive hay basket 100.

It should be noted that when the instant inventive gate is not configured correctly, the cow is more likely to pull hay out of the basket and drop it on the ground which will likely result in an incorrect calculation of the amount of hay consumed. If this happens, a user would not be able to accurately associate cow's genetic composition with the amount of hay consumed.

In some variations there are brackets for connecting one or more of the hay basket stationary side walls to a stationary fixture to minimize movement due to the wind or other. Similarly, it may also be useful to have the basket's side walls be comprised of metal rods (as opposed to, for example, being made of solid metal or wood) as is generally illustrated in the figures. This preferred configuration makes it possible to further reduce or minimize the basket's movement in the wind. This can be important in instances where embodiments will be placed in open fields and exposed to a substantial amount of wind. Those of ordinary skill in the art will recognize that if the basket moves substantially in response to the wind this could lead to inaccurate measurement of the amount of hay consumed. Additionally, an open configuration with spaced apart metal rods of the sort illustrated herein makes it easy to visually determine if more feed needs to be added.

The basket's swing gate is designed to encourage a cow to insert her head into the basket completely. For example, in the absence of the basket, if feed is piled high in the feed bin, an animal could consume feed from the edge of the feed bin with only her nose in range of the RFID reader, possibly resulting in a feeding event that is not recorded by the system or that records feed that disappears but is not assigned to the animal that consumed it. The instant configuration makes it more likely that the length of time that a cow spends eating hay will be accurately tracked. Those of ordinary skill in the art will recognize that time spent in consumption is another important variable that, in combination with the weight of hay consumed, is an important predictor of weight gain as a function of hay intake.

It should be noted and understood that the invention is described herein with a certain degree of particularity. However, the invention is not limited to the embodiment(s) set forth herein for purposes of exemplification but is limited only by the scope of the attached claims.

It is to be understood that the terms “including”, “comprising”, “consisting” and grammatical variants thereof do not preclude the addition of one or more components, features, steps, or integers or groups thereof and that the terms are to be construed as specifying components, features, steps, or integers.

The singular shall include the plural and vice versa unless the context in which the term appears indicates otherwise.

If the specification or claims refer to “an additional” element, that does not preclude there being more than one of the additional element.

It is to be understood that where the claims or specification refer to “a” or “an” element, such reference is not to be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

For purposes of the instant disclosure, the term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±10% of the base value.

When, in this document, a range is given as “(a first number) to (a second number)” or “(a first number)−(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7−91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Still further, additional aspects of the instant invention may be found in one or more appendices attached hereto and/or filed herewith, the disclosures of which are incorporated herein by reference as if fully set out at this point.

* * * * *

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A hay basket apparatus, comprising:
(a) a rectangular upper frame member sized to accommodate a hay bale, said upper frame member having an upper front, an upper back, an upper left side, and an upper right side;
(b) a rectangular lower frame member, said lower frame member having dimensions commensurate with said upper frame member, said lower frame member having a lower front, a lower back, a lower left side, and a lower right side;
(c) a plurality of spaced apart stationary frame members, wherein
(i) a first plurality of stationary frame members connect said upper left side and said lower left side,
(ii) a second plurality of stationary frame members connect said upper back and said lower back, and
(iii) a third plurality of stationary frame members connect said upper left side and said lower left side; and
(d) a rectangular swing gate, said swing gate comprising a rectangular swing frame having a swing gate top and a swing gate bottom, said swing gate top and bottom being connected by a plurality of spaced apart struts, wherein,
said swing gate top is rotatably supported at said swing gate top by said upper front of said upper frame member.

2. The hay basket apparatus according to claim 1, wherein said upper frame member has dimensions larger than said dimensions of said lower frame member.

3. The hay basket apparatus according to claim 1, wherein said lower frame member is a closed rectangle.

4. The hay basket apparatus according to claim 1, wherein said plurality of stationary frame members each comprise a square steel tube.

5. The hay basket apparatus according to claim 1, wherein said plurality of struts of said swing frame each comprise a square steel tube.

6. The hay basket apparatus according to claim 1, further comprising a left side and a right side panel,
said left side panel extending from said upper left side of said upper frame member proximate to said upper back to said lower left side of said lower frame member proximate to said lower back, and
(ii) said right side panel extending from said upper right side of said upper frame member proximate to said upper back to said lower right side of said lower frame member proximate to said lower back.

7. The hay basket apparatus according to claim 6, wherein said left and right side panels each have a top side panel and a bottom side panel and wherein said top side panel has a greater length than a length of said bottom side panel.

8. The hay basket apparatus according to claim 7, wherein said left and right side panels are triangular in shape.

9. The hay basket apparatus according to claim 1, further comprising:
(e) a latch affixed to one of said second plurality of stationary frame members; and
(f) a chain affixed to said swing gate proximate to said swing gate bottom and passing through said latch, wherein said latch is configured to removably secure said chain therewithin.
